(19) United States
(12) Patent Application Publication
(10) Pub. No.: US 2026/0187986 A1
(43) Pub. Date: Jul. 2, 2026

(54) IMAGE PROCESSING METHOD AND APPARATUS, COMPUTER-READABLE MEDIUM, AND COMPUTER DEVICE

(71) Applicant: Tencent Technology (Shenzhen) Company Limited, Shenzhen (CN)

(72) Inventors: Ruoxin CHEN, Shenzhen (CN); Shuang WU, Shenzhen (CN); Keyue ZHANG, Shenzhen (CN); Jiamu SUN, Shenzhen (CN); Shunli WANG, Shenzhen (CN); Yandan ZHAO, Shenzhen (CN); Ruixin ZHANG, Shenzhen (CN); Taiping YAO, Shenzhen (CN); Shouhong DING, Shenzhen (CN)

(21) Appl. No.: 19/538,666

(22) Filed: Feb. 12, 2026

Related U.S. Application Data
(63) Continuation of application No. PCT/CN2025/132459, filed on Nov. 4, 2025.

(30) Foreign Application Priority Data
Dec. 31, 2024 (CN) 202411999447.4

(51) Int. Cl. G06V 10/774; G06T 11/60; G06V 10/32; G06V 10/762; G06V 10/82; G06V 40/12; G06V 40/40

(52) U.S. Cl. CPC G06V 10/774; G06T 11/60; G06V 10/32; G06V 10/762; G06V 10/82; G06V 40/1347; G06V 40/45

(57) ABSTRACT

An image processing method is performed by a computer device, and the method including: obtaining a plurality of original images and description texts respectively corresponding to the plurality of original images; respectively converting the description texts respectively corresponding to the plurality of original images into text vectors, to obtain the text vectors respectively corresponding to the plurality of original images; performing clustering on the text vectors respectively corresponding to the plurality of original images, to obtain a plurality of original image clusters, each original image cluster having a corresponding text embedded vector; and performing semantic editing on images in the plurality of original image clusters by using their corresponding text embedded vectors, to obtain sample images of a machine learning model.

### CROSS-REFERENCE TO RELATED APPLICATIONS

This application is a continuation application of PCT Patent Application No. PCT/CN2025/132459, entitled “IMAGE PROCESSING METHOD AND APPARATUS, COMPUTER-READABLE MEDIUM, AND COMPUTER DEVICE” filed on Nov. 4, 2025, which claims priority to Chinese Patent Application No. 202411999447.4, entitled “IMAGE PROCESSING METHOD AND APPARATUS, COMPUTER-READABLE MEDIUM, AND COMPUTER DEVICE” filed on Dec. 31, 2024, all of which is incorporated by reference in their entirety.

### FIELD OF THE TECHNOLOGY

This application relates to the field of computer and communication technologies, and in particular, to an image processing method and apparatus, a computer-readable medium, and a computer device.

### BACKGROUND OF THE DISCLOSURE

Wide application of a biometric feature recognition technology makes it a mainstream identity authentication method, greatly facilitating daily life of people. Among a plurality of biometric feature recognition technologies, palm print recognition, as a non-intrusion technology, has gradually attracted attention in recent years. A palm print has unique uniqueness and stability, and is not easy to be collected over a long distance. Therefore, the palm print has a significant advantage in terms of privacy protection. However, the palm print recognition technology still faces some challenges in actual application, especially in terms of living body detection. This is mainly because a detection model is easily affected by aspects such as poor training sample quality and insufficient data during training, resulting in poor robustness and accuracy of the detection model.

### SUMMARY

Embodiments of this application provide an image processing method and apparatus, a computer-readable medium, and a computer device.

Other features and advantages of this application will become obvious through the following detailed description, or may be partially learned through practice of this application.

According to an aspect of the embodiments of this application, an image processing method is performed by a computer device, the method including: obtaining a plurality of original images and description texts respectively corresponding to the plurality of original images; respectively converting the description texts respectively corresponding to the plurality of original images into text vectors, to obtain the text vectors respectively corresponding to the plurality of original images; performing clustering on the text vectors respectively corresponding to the plurality of original images, to obtain a plurality of original image clusters, each original image cluster having a corresponding text embedded vector; and performing semantic editing on images in the plurality of original image clusters by using their corresponding text embedded vectors, to obtain sample images of a machine learning model.

According to an aspect of the embodiments of this application, a non-transitory computer-readable medium is provided, having a computer program stored therein, the computer program, when executed by a processor of a computer device, causing the computer device to implement the image processing method according to the foregoing embodiments.

According to an aspect of the embodiments of this application, a computer device is provided, including: one or more processors; and a storage apparatus, configured to store one or more computer programs, the one or more computer programs, when executed by the one or more processors, causing the computer device to implement the image processing method according to the foregoing embodiments.

Details of one or more embodiments of this application are provided in the following accompanying drawings and descriptions below. Other features, objectives, and advantages of this application become clear with reference to the specification, the accompanying drawings, and the claims.

### BRIEF DESCRIPTION OF THE DRAWINGS

To describe the technical solutions in the embodiments of this application more clearly, the following briefly describes the accompanying drawings required for describing the embodiments. Apparently, the accompanying drawings in the following description show merely some embodiments of this application, and a person of ordinary skill in the art may derive other accompanying drawings from the disclosed accompanying drawings without creative.

FIG. 1 is a schematic diagram of an exemplary system architecture to which a technical solution according to an embodiment of this application is applicable.

FIG. 2 is a schematic diagram of a palm authentication payment scenario to which a technical solution according to an embodiment of this application is applicable.

FIG. 3 is a schematic diagram of a face recognition scenario to which a technical solution according to an embodiment of this application is applicable.

FIG. 4 is a flowchart of an image processing method according to an embodiment of this application.

FIG. 5 is a flowchart of an image processing method according to an embodiment of this application.

FIG. 6 is a schematic diagram of a palm region detection box according to an embodiment of this application.

FIG. 7 is a schematic diagram of a palm center region detection according to an embodiment of this application.

FIG. 8 is a schematic diagram of a process of generating a text embedded vector of an image cluster according to an embodiment of this application.

FIG. 9 is a schematic diagram of a generated image according to an embodiment of this application.

FIG. 10 is a schematic diagram of model training according to an embodiment of this application.

FIG. 11 is a schematic diagram of a palm image processing process according to an embodiment of this application.

FIG. 12 is a block diagram of an image processing apparatus according to an embodiment of this application.

FIG. 13 is a schematic structural diagram of a computer system adapted to implement a computer device according to an embodiment of this application.

### DESCRIPTION OF EMBODIMENTS

The following clearly and completely describes the technical solutions in the embodiments of this application with reference to the accompanying drawings in the embodiments of this application. Apparently, the described embodiments are merely some but not all of the embodiments of this application. All other embodiments obtained by a person of ordinary skill in the art based on the embodiments of this application without creative efforts shall fall within the protection scope of this application.

In this application, the described features, structures, or characteristics may be combined in one or more exemplary embodiments in any suitable manner. In the following descriptions, many specific details are provided to provide a full understanding of the embodiments of this application. However, a person skilled in the art is to be aware that, the technical solutions in this application may be implemented without all detailed features in the embodiments, and one or more specific details may be omitted, or another method, component, apparatus, or operation may be used.

In the embodiments of this application, the term “module” or “unit” refers to a computer program with a predetermined function or a part of a computer program, and works together with other relevant parts to achieve a predetermined objective, and may be all or partially implemented by using a software, a hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

The block diagrams shown in the accompanying drawings are merely functional entities and do not necessarily correspond to physically independent entities. In other words, the functional entities may be implemented in a software form, or implemented in one or more hardware modules or integrated circuits, or implemented in different networks and/or processor apparatuses and/or microcontroller apparatuses.

The flowcharts shown in the accompanying drawings are merely examples for descriptions, do not necessarily include all content and operations/steps, and are not necessarily executed in described orders. For example, some operations/steps may be further divided, while some operations/steps may be combined or partially combined. Therefore, an actual execution order may change according to an actual case.

“Plurality of” mentioned in this specification means two or more. “And/or” describes an association relationship for associated objects and represents that three relationships may exist. For example, A and/or B may represent the following three cases: Only A exists, both A and B exist, and only B exists. The character “/” typically represents an “or” relationship between the associated objects.

In this application, before related data (for example, user data such as a palm image of a user) of the user is collected and in a process of collecting the related data of the user, a prompt interface or a pop-up window may be displayed. The prompt interface or the pop-up window are configured for prompting the user that the related data of the user is currently collected, so that in this application, only after a confirmation operation perform by the user on the prompt interface or the pop-up window is obtained, a related operation of obtaining the related data of the user is started, and otherwise (that is, when the confirmation operation performed by the user on the prompt interface or the pop-up window is not obtained), the related operation of obtaining the related data of the user ends, that is, the related data of the user is not obtained. In other words, in this application, all collected user data is collected with consent and authorization of a user, and collection, use and processing of the related data of the user need to comply with the relevant laws, regulations and standards of relevant countries and regions.

In present society, wide application of a biometric feature recognition technology makes it a mainstream identity authentication method, greatly facilitating daily life of people. Among a plurality of biometric feature recognition technologies, palm print recognition, as a non-intrusion technology, has gradually attracted attention in recent years. A palm print has unique uniqueness and stability, and is not easy to be collected over a long distance. Therefore, the palm print has a significant advantage in terms of privacy protection.

However, the palm print recognition technology still faces some challenges in actual application, especially in terms of living body detection. Specifically, a palm print living body detection technology provided in a related technology mainly faces the following problems: First, because palm prints of different individuals are greatly different and widely distributed, it is difficult to collect enough data to cover all possible real human palm print images. Consequently, when a deep learning model in the related technology is prone to misjudgment when encountering an unseen palm print. Second, a deep convolutional network-based palm print living body detection model in the related technology is insufficient in terms of robustness, and is prone to overfitting. Even if the model is trained by using a large amount of data, the misjudgment may occur when an angle or a lighting condition of an attack sample (namely, a negative sample) is slightly adjusted. Finally, because manufacturing of attack data of some types consumes a lot of time or costs (for example, cropped paper or a palm model), a quantity of pieces of data collected in this batch is relatively small, and a lack of data causes a poor interception effect of the model on the type of attack. This is also an important problem of current model training. The attack sample refers to negative sample data configured for training a machine learning model. In this application, when the machine learning model is configured to detect a living body (that is, detect whether an image is from a real human body), the attack sample may simulate an image of a non-real human body. For example, in a palm print recognition scenario, a palm print image made from cropped paper, a palm model image, and the like all belong to the attack sample.

Based on the foregoing problems, in the embodiments of this application, a new technical solution is provided. Semantic editing processing may be performed on original images of biological features (for example, a palm print and a face), to generate images with different semantic features, to enrich diversity of training data sets, and cover more scenarios, angles, and changes. In this way, a generalization capability and robustness of a model are improved, a model overfitting phenomenon is reduced, and performance and reliability of the machine learning model are effectively improved.

Specifically, as shown in FIG. 1, a system architecture 100 to which the technical solution of this embodiment of this application is applicable may include a terminal device 110, a network 120, and a server 130. The terminal device 110 may include a smartphone, a tablet computer, a notebook computer, an intelligent voice interaction device, an intelligent appliance, a vehicle-mounted terminal, an aircraft, or the like. The server 130 may be a server offering different kinds of services. The server may be an independent physical server, or may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The network 120 may be a medium providing a communication connection between the terminal device 110 and the server 130, and may be, for example, a wired communication link or a wireless communication link.

The system architecture in this embodiment of this application may be any quantity of terminal devices 110, any quantity of networks 120, and any quantity of servers 130 according to an implementation requirement. For example, the server 130 may be a server cluster that includes a plurality of server devices.

In an embodiment of this application, a user may send to-be-recognized information to the server 130 through the terminal device 110 over the network 120, for example, send a face image, a segment of to-be-recognized voice, an image including a palm print, an image including an iris, or the like. After receiving the to-be-recognized information, the server 130 may extract a feature from the information by using a trained machine learning model (for example, a palm print recognition model) for recognition processing. After obtaining a recognition result, the server 130 may return the recognition result to the terminal device 110 over the network 120.

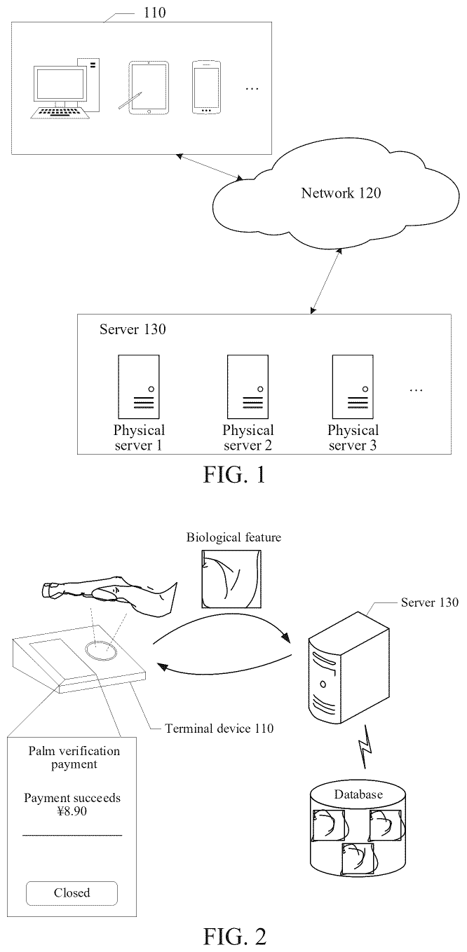

In a specific application scenario, as shown in FIG. 2, the terminal device 110 may be a device configured to capture a palm print image, and the user may perform a payment operation by verifying a palm print. Specifically, when a palm print image collection condition is met, the terminal device 110 may collect a palm print image of a user. The palm print image collection condition includes but is not limited to: An order of the user is confirmed, it is detected that a palm print image input entry is triggered, a registration operation of a palm print image is detected, a camera captures that there is a collectable palm print image in a collection region, and the like.

The terminal device 110 may send the collected palm print image to the server 130, so that the server 130 verifies, according to registered palm print information stored in a database, the palm print image sent by the terminal device 110. Alternatively, the terminal device 110 may perform verification on the collected palm print image based on a database of the terminal device 110. If the server 130 determines that the palm print image sent by the terminal device 110 has relatively high similarity with the registered palm print information stored in the database (for example, the similarity is greater than or equal to 95%), the server 130 may determine, according to this, an account associated with the registered palm print information, and further may perform bill deduction from the account, to complete a palm verification payment operation. Then, the server 130 may return result information of the palm verification payment to the terminal device 110.

When the palm print image is verified, living body detection may be further performed on the palm print image, that is, it is detected whether the palm print image collected by the terminal device 110 is from a real human body. Similarity comparison is performed only when it is determined that the palm print image collected by the terminal device 110 is from a real human body.

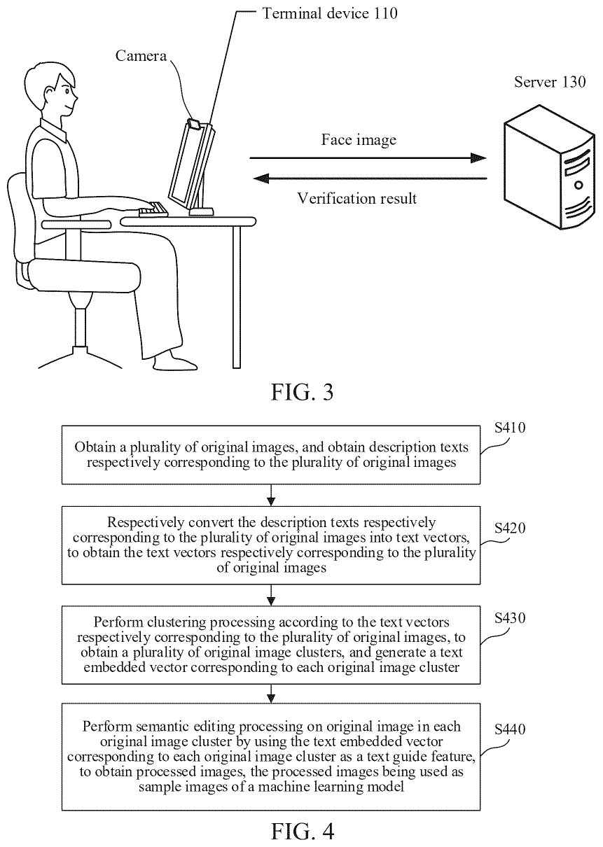

In another specific application scenario, as shown in FIG. 3, a camera is mounted on the terminal device 110, and the camera may collect a face image. In an example, if a user needs to log in to an account of an online bank, the camera mounted on the terminal device 110 may collect a face image of the user. Then, the terminal device 110 may send the collected face image to the server 130, so that the server 130 performs, according to registered face information stored in the database, verification on the face image sent by the terminal device 110. If the server 130 determines that the face image sent by the terminal device 110 has relatively high similarity with the registered face information stored in the database (for example, the similarity is greater than or equal to 98%), the server 130 may determine, according to this, that verification on the face image succeeds, further perform feedback on a verification result to the terminal device 110, may also determine an online bank account associated with the registered face information, and further perform an operation of logging in to the online bank account.

When verification is performed on the face image, living body detection may be further performed on the face image, that is, it is detected whether the face image collected by the terminal device 110 is from a real human body. Similarity comparison only when it is determined that the face image collected by the terminal device 110 is from a real human body.

The technical solutions in the embodiments of this application may be applied to both recognition of biological features such as a palm print or a face and recognition scenarios of biological features such as a fingerprint, an iris, and a voiceprint, may also be applied to recognition of another living body such as an animal or a plant.

In an embodiment of this application, the server 130 can improve recognition accuracy of a model through model training. Before training, to enrich diversity of training data sets to improve a generalization capability and robustness of the model, the server 130 may obtain a plurality of original images (if in a palm print recognition scenario, the original image may be an image including a palm print; if in a face recognition scenario, the original image may be an image including a face, or the like) and description texts respectively corresponding to the plurality of original images. Then, the description texts respectively corresponding to the plurality of original images are respectively converted into text vectors, to obtain the text vectors respectively corresponding to the plurality of original images. Subsequently, clustering processing is performed according to the text vectors respectively corresponding to the plurality of original images, to obtain a plurality of original image clusters, and a text embedded vector corresponding to each original image cluster is generated. Further, semantic editing processing is performed on original images in each original image cluster by using the text embedded vector corresponding to each original image cluster as a text guide feature, to obtain processed images. These processed images may be used as expanded sample images to train a machine learning model. In view of the above, in the technical solutions of the embodiments of this application, images with different semantic features may be generated, to enrich the diversity of the training data sets, and cover more scenarios, angles, and changes, so as to improve the generalization capability and robustness of the model.

Implementation details of the technical solutions of the embodiments of this application are described below in detail.

FIG. 4 is a flowchart of an image processing method according to an embodiment of this application. The image processing method may be performed by a computer device. The computer device may be a server, or may be another device. Referring to FIG. 4, the image processing method includes at least operation S410 to operation S440, which are described in detail as follows.

Operation S410: Obtain a plurality of original images, and obtain description texts respectively corresponding to the plurality of original images.

In some exemplary embodiments, the original image may be an obtained image configured for training a machine learning model. For example, if an application scenario is a palm print recognition scenario, the obtained original image may be an image including a palm print. If an application scenario is a face recognition scenario, the obtained original image may be an image including a face. If an application scenario is a fingerprint recognition scenario, the obtained original image may be an image including a fingerprint.

In some embodiments, if the machine learning model may be configured to detect a living body, that is, detect whether an image is from a real human body, the original image in this embodiment of this application may be negative sample data configured for training the machine learning model, that is, may be attack sample data. For example, in the palm print recognition scenario, the original image may be a palm print image made from cropped paper, a palm model image, or the like.

The palm print image made from cropped paper may be that a printed or copied palm print pattern is pasted to a piece of paper or another similar material, and then the piece of paper or another similar material is cropped into a palm shape, to simulate a real palm. The palm model image may be that a three-dimensional palm model (which is usually made of silicon, gypsum, or another plastic material) is manufactured, and a palm print pattern is printed or sculpted on the model, to simulate a real palm.

In some exemplary embodiments, the description texts corresponding to the original images may be automatically generated by using a model. For example, natural language description respectively corresponding to the plurality of original images may be generated by using a pre-training model as the description texts.

In some embodiments, the pre-training model may be, for example, a bootstrap language-image pre-training 2 (BLIP2) model. The BLIP2 model is an advanced multi-modal pre-training model, combines image and text processing capabilities, and can generate natural language descriptions, answer questions about an image, and perform tasks such as visual reasoning when the image is given. A core advantage of the BLIP2 lies in its strong cross-modal understanding capability. Through the BLIP2, an image and a text can be mapped to a same high-dimensional semantic space, to implement high-efficient image-text alignment and interaction.

When the description text is generated by using the BLIP2 model, the original image is inputted to an image encoder of the BLIP2 model, to obtain a high-dimensional feature representation of the image, and then the feature is inputted to a text decoder. A temperature parameter of the decoder is set to 0.7, and a maximum generation length may be 50, so that natural language description is generated as the description text.

The BLIP2 model mainly includes two components: the image encoder and the text decoder. The image encoder is responsible for converting an input image into a high-dimensional feature representation. The text decoder is responsible for generating a corresponding text description or answering a question according to the feature generated by the image encoder. In addition, a comparison learning module is further introduced into the BLIP2 model, to enhance alignment between an image and a text in a pre-training phase. In this way, the BLIP2 model can better understand content in an image and generate a more accurate text description.

In some exemplary embodiments, the description text corresponding to the original image may be manually added. For example, when training data of the machine learning model is prepared, a description text may be manually added for an obtained image.

Operation S420: Respectively convert the description texts respectively corresponding to the plurality of original images into text vectors, to obtain the text vectors respectively corresponding to the plurality of original images.

The text vector is a vector obtained by converting the description text corresponding to the original image by using a particular technology (for example, a term frequency-inverse document frequency (TF-IDF) technology, a bag of words model, an N-gram model, or a word embedding technology), and is configured for representing a feature of the description text, to facilitate subsequent operations such as clustering processing.

In some exemplary embodiments, a term frequency-inverse document frequency (TF-IDF) technology may be used to respectively convert the description texts respectively corresponding to the plurality of original images into the text vectors. Specifically, TF-IDF is a statistical method widely applied to the fields of information retrieval and text mining, and is configured for evaluating importance of a word in a document or a corpus. A core idea of the TF-IDF is that if a word appears more frequently in a document but appears less frequently in the entire corpus, the word has a higher distinction degree and importance for the document.

In some exemplary embodiments, the bag of words (BoW) model, the N-gram model, the word embedding technology, or the like may alternatively be used to respectively convert the description texts into the text vectors. The bag of words model is a simple text vectorization method. Through the bag of words model, a text is represented as a quantity of times of occurrence of each word in a vocabulary or a binary indicator (whether each word occurs), each document is represented as a vector of a fixed length, and a dimension of a vector is equal to a size of a vocabulary. The N-gram model is an extension of the bag of words model, and considers not only an occurrence frequency of a single word, but also a plurality of adjacent words (namely, a combination of N words). Some local word order information can be captured through the N-gram, to better represent a text structure. The word embedding technology is a technology of mapping a word into a low-dimensional continuous vector space, so that words having similar semantics are relatively close to each other in the vector space. A common word embedding technology may include, for example, Word2Vec, GloVe, and FastText.

When a specific technology is selected, the TF-IDF technology may be selected when word richness of a description text is relatively high and importance of a specific word is expected to highlight. The bag of words model may be selected when more attention is paid to an occurrence frequency of a word in a text without considering a word order. The N-gram model may be selected when local word order information in a text needs to be captured. The word embedding technology may be selected when it is expected that words having similar semantics are relatively close to each other in the vector space.

Operation S430: Perform clustering processing according to the text vectors respectively corresponding to the plurality of original images, to obtain a plurality of original image clusters, and generate a text embedded vector corresponding to each original image cluster.

The text embedded vector is a vector obtained through learning after textual embedding processing is performed on each original image cluster, can represent a semantic concept corresponding to the image cluster, and may be used as a text guide feature for performing semantic editing processing on the original image.

In some exemplary embodiments, during the clustering processing, clustering processing may be performed on the text vectors respectively corresponding to the plurality of original images, to obtain a plurality of text vector clusters, and then the plurality of text vector clusters are mapped to the plurality of original image clusters according to text vectors included in the plurality of text vector clusters and the text vectors respectively corresponding to the plurality of original images. In this embodiment, the text vectors are generated according to the description texts of the original images. Therefore, the text vectors generated according to the description texts are in one-to-one correspondence with the original images, so that the original image clusters can be obtained through mapping according to the text vector clusters.

In some embodiments, during the clustering processing, clustering processing may alternatively be directly performed on the plurality of original images according to the text vectors respectively corresponding to the plurality of original images. In this way, the plurality of original image clusters may be directly obtained.

When a clustering manner is selected, when there are a large quantity of original images and features of text vectors are complex, data can be processed more efficiently in a manner of first performing text vector clustering and then mapping to an original image cluster; and when there are a small quantity of original images and text vectors are tightly associated with the original images, clustering processing may be directly performed on the original images according to the text vectors.

In specific application, clustering processing may be performed according to the text vectors respectively corresponding to the plurality of original images by using a K-means clustering algorithm, to obtain the plurality of original image clusters, and the text embedded vector corresponding to each original image cluster is generated. A principle of the K-means clustering processing algorithm is that data points are allocated to K different clusters in an iterative manner, so that similarity of data point within a cluster is relatively high, and similarity of data points between clusters is relatively low. Specific operations are: first randomly initializing K cluster centers, then calculating a distance between each data point and each cluster center, allocating a data point to a cluster in which a cluster center closest to the data point is located, then recalculating a cluster center of each cluster, and repeating the foregoing operations until the cluster center no longer changes or a maximum quantity of iterations is reached.

Operation S440: Perform semantic editing processing on original images in each original image cluster by using the text embedded vector corresponding to each original image cluster as a text guide feature, to obtain processed images, the processed images being used as sample images of a machine learning model.

The semantic editing processing refers to an editing operation performed on the original images in each original image cluster by using the text embedded vector corresponding to each original image cluster as the text guide feature and by using a pre-training image generation model, and aims to generate processed images having different semantic features. These processed images may be used as sample images for the machine learning model.

In some exemplary embodiments, semantic editing processing may be performed on the original images in each image cluster by using the pre-training image generation model. Specifically, semantic editing processing may be performed on the original images in each original image cluster by using the text embedded vector corresponding to each original image cluster as the text guide feature and by using the trained image generation model.

In some embodiments, the pre-training image generation model may be obtained by using an image and a text prompt in a preset scenario and by training a multi-scenario-oriented image generation model. The set scenario may be set according to an actual application scenario. For example, in a palm print recognition scenario, the image may be a palm print image, and the text prompt is a text prompt describing the palm print image. In a face recognition scenario, the image may be a face image, and the text prompt is a text prompt describing the face image.

A specific training process is inputting an image and a corresponding text prompt in a preset scenario, and setting a batch size of training to 32, a learning rate to 0.0001, and a quantity of rounds of training to 50. In each round of training, input data is transmitted into the multi-scenario-oriented image generation model, and the model outputs a prediction result. A cross-entropy loss function

$$L = - {\sum }_{i = 1}^{n} {y}_{i} log ( {p}_{i} )$$

is minimized where L represents a cross-entropy loss, n represents a quantity of samples, yᵢ represents a real label of an i^{th} sample, and pᵢ represents a prediction probability of the i^{th} sample by the model, to update a model parameter, so as to obtain the pre-training image generation model.

In some exemplary embodiments, when semantic editing processing is performed on the original images, editing processing may be performed by using a stable diffusion edit (SDEdit) technology. The SDEdit is an image editing technology based on a stable diffusion model, and allows a user to locally or globally modify an existing image by using a text prompt or a mask. The SDEdit combines a strong generation capability of the diffusion model and a text-to-image capability, so that the user can accurately edit a specific region or element while retaining most features of the original images. When local editing is performed, the user may specify, in an image by using the mask, a region that needs to be edited, for example, remove an unnecessary object, replace a background, or modify a color or a texture of an object. When global editing is performed, the user may perform global modification such as style transformation and scene change on an entire image by using the text prompt, for example, convert a daytime scene into night, or convert an indoor scene into an outdoor scene. When an object insertion/deletion operation is performed, the user may add a new object to an image or remove an existing object by using the text prompt, for example, add an animal to a scenery photograph, or remove a person from a group of people. When attribute modification is performed, the user may modify an attribute of an object in an image, for example, change a hair style, clothes, an emotion, or the like of a person.

In the technical solution of the embodiment shown in FIG. 4, semantic editing processing is performed on the original images to generate images having different semantic features, so that diversity of training data sets can be enriched, and more scenarios, angles, and changes can be covered, a generalization capability and robustness of the model are improved, a phenomenon of overfitting of the model is reduced, and performance and reliability of the machine learning model are effectively improved.

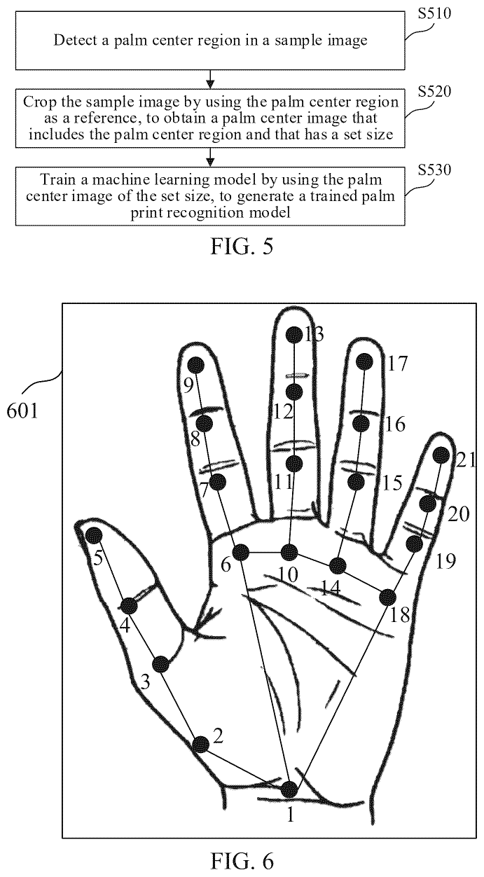

With reference to FIG. 5, the following describes, by using an example in which a sample image includes a palm image, a process of training a machine learning model to obtain a palm print recognition model in an embodiment of this application. FIG. 5 is a flowchart of an image processing method according to an embodiment of this application. The image processing method may be performed by a computer device. The computer device may be a server, or may be another device. Referring to FIG. 5, the image processing method includes at least operation S510 to operation S530, which are described in detail as follows.

Operation S510: Detect a palm center region in a sample image.

In some exemplary embodiments, the sample image may include a sample image generated in the embodiment shown in FIG. 4, or may include a palm image collected by an image collection device. In other words, the technical solution of the embodiment shown in FIG. 5 may be performed for a sample image obtained in any manner.

In some exemplary embodiments, a process of detecting the palm center region in the sample image may be: performing palm region detection on the sample image, to determine a palm region included in the sample image, then performing key point detection on the palm region, calculating a center of a palm center circle in the palm region according to a key point obtained through detection, and further determining the palm center region in the palm region according to the center of the palm center circle.

In some embodiments, the palm region may be detected in the sample image through palm region of interest (RoI) detection. For example, as shown in FIG. 6, a region selected by using a detection box 601 is a detected palm region. Then, the key point in the palm region may be detected. For example, a key point 1 to a key point 21 shown in FIG. 6 are all key points in the palm region. In actual application, all the 21 key points may be detected in the palm region, or only some of the 21 key points may be detected.

In some exemplary embodiments, the key point in the palm region may be detected by using a deep learning method. For example, 21 key points of a hand may be detected by using a MediaPipe Hands model or an OpenPose model, and coordinates of each key point are outputted. In another embodiment of this application, the key point may be detected by using a geometrical feature of the palm image. For example, a contour of a palm may be extracted by using an edge detection algorithm, then a convex hull of the contour of the palm is calculated by using a convex hull algorithm, to obtain a smallest convex polygon including all contour points, then key points such as a fingertip and a finger root may be positioned through detection of a concave point on the convex hull (namely, a difference point between the convex hull and an actual contour), and further the key points such as the fingertip, the finger root, and a wrist are matched according to a position and a shape of the concave point. Alternatively, the key point in the palm region may be detected by using another method. This is not limited in this embodiment of this application.

In some exemplary embodiments, when the center of the palm center circle in the palm region is calculated according to the detected key point, a geometric center-based averaging algorithm may be used. For example, after a plurality of key points in the palm region are detected, to more accurately estimate a palm center position, key points related to a palm center may be selected, for example, a key point of a palm root (namely, a key point at a wrist, that is, a key point 1 shown in FIG. 6), and key points of finger roots (for example, a key point 6, a key point 10, a key point 14, and a key point 18 shown in FIG. 6, respectively corresponding to finger roots of an index finger, a middle finger, a ring finger, and a little finger) may be used, and then a geometric center of these key points may be calculated, that is, an average value of coordinates of the selected key points is obtained, to obtain an approximate center of the palm center circle. In another embodiment of this application, the center of the palm center circle may alternatively be calculated through weighted averaging, that is, a corresponding weight is allocated to a detected key point, for example, a relatively large weight is set for a key point of a finger root, a moderate weight is set for a key point in a middle of fingers, and a relatively small weight is set for a key point of a fingertip, and then the center of the palm center circle is obtained through calculation in a weighted averaging manner. Certainly, in another embodiment of this application, the center of the palm center circle may alternatively be calculated by using another method. For example, a smallest enclosing circle algorithm based on a palm geometric structure may be used. In other words, a smallest circle that can surround all contour points is calculated by using the smallest enclosing circle algorithm (for example, a Welzl algorithm). A center of the smallest circle may be used as an approximate center of the palm center circle, and then the center of the palm center circle is obtained by using the smallest enclosing circle algorithm.

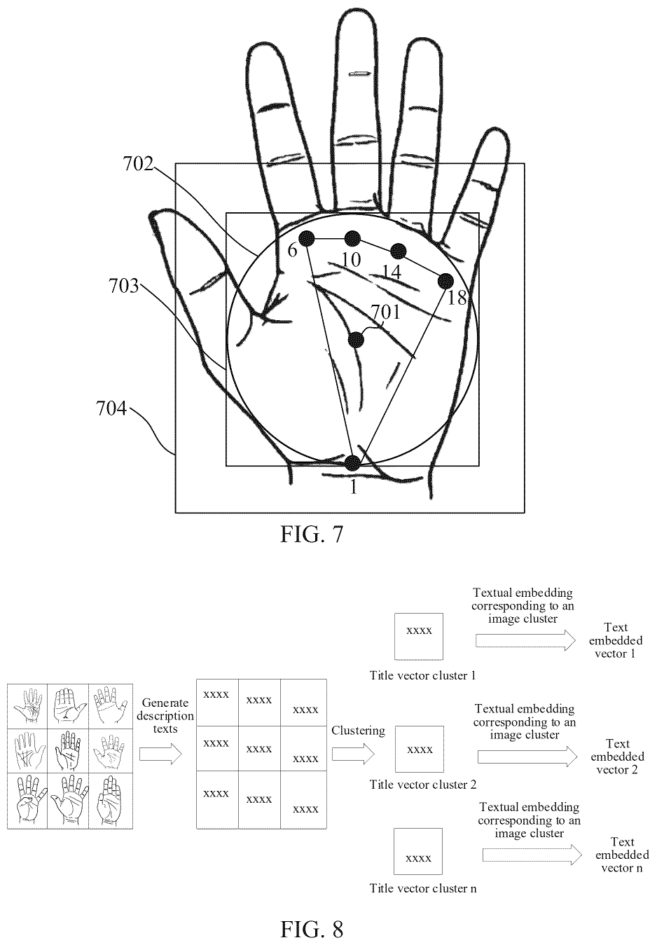

In some exemplary embodiments, the palm center region may include a region represented by a circumscribed rectangle of the palm center circle. Referring to FIG. 7, the center of the palm center circle may be represented as 701, the palm center circle may be represented as 702, and the circumscribed rectangle of the palm center circle is 703. Therefore, the palm center region may be a region represented by the circumscribed rectangle 703. In some embodiments, the palm center circle may be generated based on the center of the palm center circle and by using a set length as a radius, and the set radius is a radius of the palm center circle.

In some embodiments, when the radius of the palm center circle is determined, a point related to a palm center may be selected from key points of a palm, for example, key points of finger roots (for example, a key point 6, a key point 10, a key point 14, and a key point 18 shown in FIG. 6 and FIG. 7, respectively corresponding to finger roots of an index finger, a middle finger, a ring finger, and a little finger) are selected, then a distance between each of these key points and the center of the palm center circle is calculated, then an average value of distances between all the key points and the center is used as the radius of the palm center circle, or the average value is corrected (for example, by increasing a set value, reducing a set value, or multiplying the average value by a set multiple), to obtain the radius of the palm center circle. In another embodiment of this application, the radius of the palm center circle may alternatively be determined by using another method. For example, a statistical method based on a palm geometric structure may be used. For example, a distance between each key point in a palm region and the center of the palm center circle is calculated, then statistical analysis is performed on distances between all contour points and the center of the palm center circle, and an average value of all the distances is used as the radius, or a median of all the distances is used as the radius. If the smallest enclosing circle algorithm in the foregoing embodiment is used, the palm center circle may also be obtained.

Operation S520: Crop the sample image by using the palm center region as a reference, to obtain a palm center image that includes the palm center region and that has a preset size.

In some exemplary embodiments, the cropping the sample image by using the palm center region as a reference may be: expanding a width and a height of the circumscribed rectangle by a set multiple by using a region in which the circumscribed rectangle of the palm center circle is located as a reference, to obtain an expanded palm center region, and then cropping the expanded palm center region in the sample image, to obtain the palm center image. In the technical solution of this embodiment, through expansion processing, it can be ensured that palm information completely appears in the palm center image, and the processed palm center image has approximately a same size, so as to facilitate training of the model. In some embodiments, the set multiple may be set according to an actual requirement, for example, may be set to 0.5 times, 1 time, or 1.5 times. When it is expected to retain more information around the palm, a relatively large set multiple such as 1.5 may be selected. When it is expected that the cropped image is more focused on the palm center region, a relatively small set multiple such as 0.5 may be selected. When it is expected to maintain palm information integrity without increasing an image size too much, a set multiple of 1 may be selected. When the sample image is cropped by using the palm center region as a reference, the width and the height of the circumscribed rectangle are expanded according to the selected set multiple by using the region in which the circumscribed rectangle of the palm center circle is located as a reference, to obtain the expanded palm center region. Then, the expanded palm center region is cropped from the sample image, to obtain the palm center image.

In a specific example, as shown in FIG. 7, the width and the height of the circumscribed rectangle are expanded by the set multiple, to obtain the expanded palm center region shown in 704, and then the expanded palm center region may be cropped from the sample image, to obtain the palm center image.

Operation S530: Train the machine learning model by using the palm center image of the preset size, to generate a trained palm print recognition model.

In some exemplary embodiments, the machine learning model may be a multi-modal large model. The multi-modal large model includes an image encoder. Therefore, when the machine learning model is trained by using the processed palm center image of the preset size, a weight matrix of a specified network layer in the image encoder may be converted into a low-rank matrix, and then parameters in the low-rank matrix are updated in a process of training the machine learning model by using the palm center image of the preset size. In the technical solution of this embodiment, a new training task (namely, a palm print recognition task) may be rapidly adapted when most parameters of a pre-training model in the multi-modal large model remain unchanged. This method not only reduces a requirement of a computing resource, but also effectively avoids overfitting. In some embodiments, the specified network layer may include at least one of a linear layer and an attention layer.

Specifically, the multi-modal large model may be, for example, a contrast language-image pre-training (CLIP) model. The multi-modal large model has learned of rich semantic features on a large-scale data set, but these features may not be completely applicable to a specific task (for example, palm print recognition). To make the model better adapt to a palm print living body detection task, a large quantity of parameters need to be updated in a full-parameter fine-tuning method in a related technology, which not only increases calculation costs, but also may lead to overfitting, especially in a case of limited data amount. In this application, low-rank fine-tuning is performed on some parameters of the model, a strong semantic feature of the pre-training model is retained, a new task can also be quickly adapted, and consumption of a computing resource is reduced.

In some exemplary embodiments, before the sample image is processed (for example, the palm center region is detected), the sample image may be further evaluated from a plurality of quality dimensions by using a pre-training image quality recognition model, to obtain evaluation values of the sample image in the plurality of quality dimensions, and then filtering processing is performed on the sample image according to the evaluation values of the sample image in the plurality of quality dimensions, so that a high-quality sample image can be obtained, thereby improving model training accuracy.

In some embodiments, the plurality of quality dimensions may be, for example, blur, over-exposure, over-darkness, and an excessive inclination angle. In this case, a corresponding threshold may be set to filter out a blur image, an over-exposed image, an over-dark image, an image with an excessive inclination angle, or the like. Specifically, for a blur dimension, a blur threshold is set to 0.3 (which may be adjusted according to an actual case), and when a blur evaluation value of an image is greater than 0.3, it is determined that the image is a blur image and filtered. For an over-exposure dimension, an over-exposure threshold is set to 0.8, and when an over-exposure evaluation value of an image is greater than 0.8, it is determined that the image is over-exposed and filtered. For an over-darkness dimension, an over-darkness threshold is set to 0.2, and when an over-darkness evaluation value of an image is less than 0.2, it is determined that the image is an over-dark image and filtered. For an inclination angle dimension, an inclination angle threshold is set to 15°, and when an inclination angle evaluation value of an image is greater than 15°, it is determined that the image has an excessively large inclination angle and is filtered. These corresponding thresholds are set to filter the blur image, the over-exposed image, the over-dark image, the image having an excessively large inclination angle, and the like.

In some embodiments, the pre-training image quality recognition model may be a multi-classification model, and a process of evaluating the sample image from the plurality of quality dimensions by using the pre-training image quality recognition model may be recognizing an evaluation value of the sample image in each category by using the multi-classification model, one category corresponding to one quality dimension. In this case, the multi-classification model may output an evaluation value for each category, and then determine, by using a set threshold, whether the sample image meets a requirement in this dimension.

The following describes implementation details of the technical solutions of the embodiments of this application in detail by using an application scenario of palm print recognition as an example.

In this embodiment, this application mainly provides a palm print living body detection method based on image generation based on a diffusion model and low-rank adaptation of the multi-modal large model. Specifically, robustness and generalization of a living body detection model are improved by relying on a semantic feature that is obtained from a large amount of data sets through pre-training of multi-modal large model. Considering that training the model needs a large amount of training data, and that actually collecting the large amount of data needs high time and money costs, an embodiment of this application provides a clustering and textual embedding (textual inversion)-based diffusion model generation method, to generate a high-quality attack image (namely, a negative sample image). An image generation model is aligned with existing living body data, and then a large quantity of attack images are generated to help the living body detection model learn of attack features better and resolve a problem of insufficient data. (namely, the negative sample images). The image generation model is aligned with liveness data by using existing liveness data, and then the attack image is generated on a large scale, to facilitate the liveness detection model to better learn attack feature, thereby resolving the problem of insufficient data. A robust feature learned from the large amount of data sets through the multi-modal large model is fine-tuned, and robustness of a finally learned feature is greatly enhanced. Because a feature of the large model is learned from a large amount of data, the large model is more consistent with a reality rule and has better generalization.

In an embodiment of this application, a diffusion model-based training data generation process may be mainly divided into the following three phases: Phase 1: Perform LoRA fine tuning on a generation model by using palm living body data; phase 2: Semantic-based image clustering and textual embedding processing; and phase 3: SDEdit-based image generation. processing; and phase 3: Stable diffusion edit (SDEdit)-based image generation.

Specifically, in Phase 1, an image generation model (namely, the image generation model may be a multi-modal large model) may be fine-tuned by using an image-text pair (the image is a palm living body attack image, and the text may be, for example, a “xx attack of a hand of a person of xx age xx gender”), so that the image generation model is preliminarily aligned with the palm living body data. A specific fine-tuning process is as follows: The image-text pair is inputted into the image generation model, and the model outputs a prediction result. For a linear layer and an attention layer in the model, a weight matrix W of the linear layer and the attention layer is converted to W′=W+ΔW in a low-rank manner, where ΔW=A·B, and A and B are low-rank matrixes. Assuming that a dimension of the weight matrix W is n×m, a dimension of A is n×r, a dimension of B is r×m, and r is a rank of the matrix. In this embodiment, r=16. In a training process, a loss function (for example, a cross-entropy loss function) between the prediction result and a real label is minimized, and parameters of the low-rank matrixes A and B are updated by using a gradient descent algorithm. While most parameters of the original weight matrix W remain unchanged, to fine tune the image generation model.

In Phase 2, as shown in FIG. 8, living body attack data of a category (namely, negative sample imaged including palm prints) is given, a BLIP2 model is configured to summarize content of each image to generate a corresponding text description as a title of each image. Then, the title of the image may be converted into a vector form. For example, a TF-IDF vectorizer may be configured to vectorize each title to obtain a title vector. After a title vector of each image is obtained, title vectors may be clustered by using K-means to obtain title vector clusters (a title vector cluster 1, a title vector cluster 2, a title vector cluster n, and the like shown in FIG. 8) having similar semantics. Because the title vectors are in one-to-one correspondence with the images, the title vector may be mapped to image clusters. Then, text embedding (textual inversion) processing is performed on each image cluster to learn a text embedded vector (textual embedding) of a corresponding semantic concept of each image cluster, and then the embedded text vector may be configured for instructing the image generation model to generate a corresponding image.

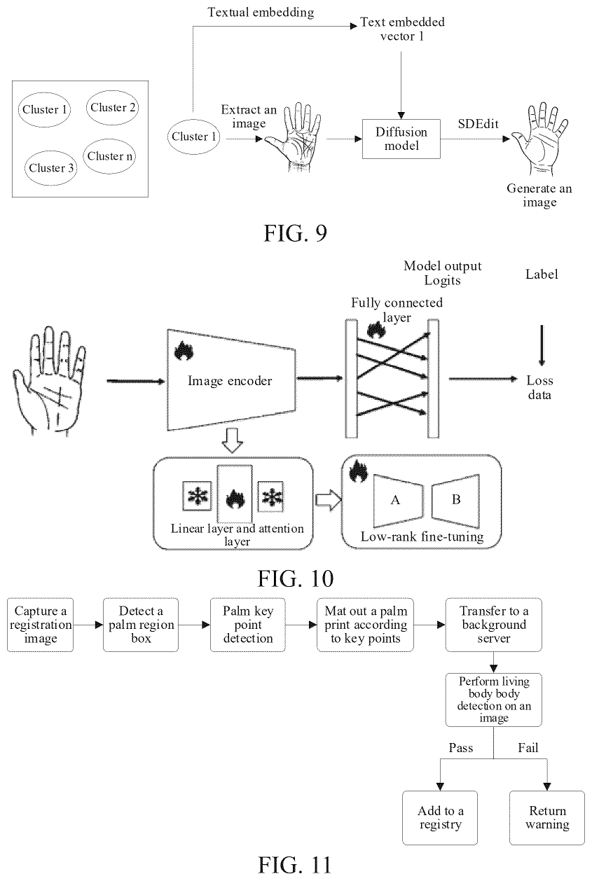

In Phase 3, as shown in FIG. 9, for each image in each image cluster obtained through clustering, semantic editing may be performed on the image based on the image generation model (namely, a diffusion model shown in FIG. 9) obtained through fine-tuning in Phase 1, by using an SDEdit technology, and by using a text embedded vector (textual embedding) corresponding to the cluster as a text guide, to finally obtain a generated image. In this embodiment of this application, during actual use, an editing strength of the SDEdit may be set to 0.4 (0 corresponds to no modification, and 1.0 corresponds to completely generation from scratch) or another value, to implement partial editing processing on an image. The image generated in this embodiment may be configured for training a palm print living body model below.

In some exemplary embodiments, for a training sample image configured for training the palm print living body model, in this embodiment of this application, palm key point detection and the following processing may be performed.

Operation 1: Palm region of interest (RoI) detection: A quality score of the training sample image may be calculated by using an image quality determining algorithm. This operation aims to filter out a faulty image (for example, a smudged palm print, a blur image, an over-exposed image, over-dark light, or an excessively large inclination angle of a palm), to avoid a living body detection misjudgment caused by an image quality defect. Then, a detection box (601 shown in FIG. 6) in which a palm is located is detected by using a palm RoI detection algorithm, and then {x,y,w,h} represents a palm region detection box, where x and y respectively represent a horizontal coordinate and a vertical coordinate of an upper left corner of the palm region detection box, and w and h respectively represent a width and a height of the palm region detection box.

Operation 2. Palm key point detection: A palm RoI is detected by using a palm key point detection algorithm, to obtain 21 key points in a palm region (as shown in FIG. 6). A palm key point detection result is:

$$P = {\{ {p}^{k} \}}_{k = 1}^{21} ,$$

where p^{k} represents coordinates of a kₜₕ key point.

Operation 3: Palm image cropping: Considering that a palm print living body detection model is interfered with by a large quantity of complex background information (for example, a screen feature that may exist in a background) in actual application, in this embodiment of this application, a palm region is cropped by using a palm center point-based following algorithm, to weaken interference of the background to the living body detection model. Specifically, a center (701 shown in FIG. 7) of a palm center circle is first calculated based on the palm key points, and then a palm cropping box (for example, a circumscribed rectangle 703 of a palm center circle 702 shown in FIG. 7) is calculated by using the center as a center. In an actual deployment link, a width and a height of a cropping region may be respectively expanded by 150%, to ensure that complete palm information appears in the cropping region.

In the foregoing processing, image quality can be ensured through filtering processing, and same palm cropping is performed on an image, to ensure that a difference between different real palm data is not excessively large, so as to facilitate model training convergence. In an actual training process, collected real palm data and generated attack data may be mixed as a training set.

In an embodiment of this application, when model training is performed, an image linear layer and an attention layer in an image encoder of a multi-modal large model such as a CLIP architecture may be respectively converted into low-rank matrixes. by using an LoRA low-rank fine-tuning method. Specifically, for example, if a weight matrix of a layer (which may be the image linear layer, or the attention layer) in a pre-training model is W, W may be converted to W′ in a low-rank manner:

$${W}^{′} = W + Δ W .$$

ΔW=A·B; and A and B are low-rank matrixes. Assuming that a dimension of the weight matrix is n×m, a dimension of A is n×r, a dimension of B is r×m, where r is a rank of the matrix, and a value of r is a preset value, and is usually far less than n and m. In this embodiment of this application, a rank r=16 may be used as the rank of the matrix. In some embodiments, during actual training, zero initialization may be performed on the matrixes A and B. In this way, the initialized ΔW is zero, and an initial state of the model is the same as that of the pre-trained model. When the rank of the matrix is r=16, a new training task (namely, a palm print recognition task) may be rapidly adapted when most parameters of the pre-training model in the multi-modal large model remain unchanged. This setting can effectively balance requirements of computing resources, avoid a large amount of computation due to excessive parameters, and also avoid overfitting.

A network structure of a multi-modal large model architecture-based deep learning classification model used in this embodiment of this application may be shown in FIG. 10. First, feature extraction is performed on original images by using the image encoder of the multi-modal large model. Subsequently, authenticity of a palm print image is determined by using a fully connected neural network layer. In a training fine-tuning phase, data is first inputted into a low-rank conversion image encoder, converted into an image feature vector, and then inputted into a fully connected layer, to obtain a score (namely, Logits) of each category, for example, a category of a living body image (real) and a type of a non-living body image (fake), then a cross-entropy loss between the score and a real image label is obtained, and low-rank matrixes in a linear layer and an attention layer and a final fully connected layer in a gradient update model are back propagated. The image feature vector is a vector obtained through feature extraction on the original imager by the image encoder of the multi-modal large model, represents image feature information, and is configured for subsequent tasks such as classification. In this application, the image feature vector is inputted to the fully connected layer to determine authenticity of the palm print image.

After model training is completed, living body detection may be performed on the palm print image by using a trained model. Specifically, as shown in FIG. 11, a user may capture a registered image of a palm by using a terminal device, and then an application program on the terminal device may automatically detect a position of the palm in the image and calculate a boundary box in which the palm is located. Next, the application program may recognize palm key points by using a palm key point detection algorithm according to the inputted original image and the palm boundary box. After obtaining key point information, the application program may process the original image by using a palm matting algorithm according to the boundary box and the key points of the palm, to remove interference from the background to a living body detection effect, and obtain a palm print image. The palm print image on which matting processing is performed is then transferred to a background server. The image is analyzed by using a living body detection model (namely, the model obtained through training in the foregoing embodiment) of the background server, to determine whether the image is a palm actually photographed by the user or another non-living body image such as a recaptured image, so as to effectively improve security and reliability of palm print recognition. This technical solution may be applied to a palm print registration scenario, that is, palm print registration processing may be performed after a living body image is detected. The palm matting algorithm is an algorithm in which the original image is processed according to the boundary box and the key points of the palm, to remove interference from the background to the living body detection effect, so that the palm print image can be obtained.

In another embodiment of this application, after collecting the palm print image, the terminal device may alternatively directly send the palm print image to the background server, and then the background server performs processing of detecting a palm region box and key points, and matting out the palm print image. A processing process of detecting the palm region box, detecting the key points, and matting out the palm print image is similar to the processing process for the training sample image in the foregoing embodiment. In addition, if the terminal device enters a segment of palm video, one or more frames of images of relatively high quality may be selected from the segment of palm video for subsequent processing. When an image of relatively high quality is selected, an algorithm in the foregoing embodiment may also be used to evaluate the image from a plurality of dimensions.

After a test, comparison between effects of the technical solution in this embodiment of this application and the solution in the related technology is shown in the following Table 1.

TABLE 1

| | | Palm image | Palm image | Palm image |
|---|---|---|---|---|
| | Living | obtained by | made from | made from |
| | body palm | capturing | complete | cropped |
| Pass rate | image | a screen | paper | paper |
| CNN | 98.17 | 1.63 | 0.69 | 10.76 |
| MM + Adapter | 92.47 | 23.19 | 1.53 | 13.28 |
| MM + LoRA | 99.07 | 0.37 | 0.08 | 3.17 |
| Solution of this | 99.04 | 0.15 | 0.05 | 1.68 |
| application | | | | |

An evaluation index shown in Table 1 is a pass rate. A higher pass rate of the living body palm image is desirable, and lower miss rates of attack images such as the palm image obtained by capturing the screen, the palm image made from complete paper, and the palm image made from cropped paper are desirable. The CNN shown in Table 1 refers to a technical solution for recognition by using a convolutional neural network. MM+Adapter is a technical solution for recognition by using a multi-modal model and an adapter (the adapter is a lightweight module, and is usually configured to fine-tune a pre-training model to adapt to a particular task or field). MM+LoRA is a technical solution for LoRA fine tuning by using the multi-modal model. It can be learned from comparison in Table 1 that the technical solutions in this embodiment of this application have better performance, and performance is far better than another method. After generated attack data is added, an attack error rate is further greatly reduced, indicating that the generated attack data can effectively improve an attack interception capability of the model.

In conclusion, in the technical solutions of the embodiments of this application, a strong data generation capability of the diffusion model and a strong feature extraction capability of the multi-modal large model are fully used, thereby increasing an effect of palm print living body detection. Compared with the solution in the related technology, the generated data is added, so that a model output result obtained by using the multi-modal large model obtained through low-rank fine-tuning training is more consistent with human cognition, and an attack interception effect is significantly better. For example, for a simple attack in which a recaptured image includes a clear screen border, almost 100% interception can be implemented, which is difficult to be implemented by the living body detection model in the related technology. In other words, the technical solutions in the embodiments of this application significantly improve accuracy of living body detection, generalization and robustness of the model, thereby making a palm print authentication technology more secure and reliable.

The technical solutions in the embodiments of this application may also be applied to detecting another biometric feature, for example, may be applied to a scenario such as face recognition or fingerprint recognition.

The following describes an apparatus embodiment of this application, which may be configured to perform the image processing method in the foregoing embodiments of this application. For details not disclosed in the apparatus embodiment of this application, refer to the foregoing embodiments of the image processing method of this application.

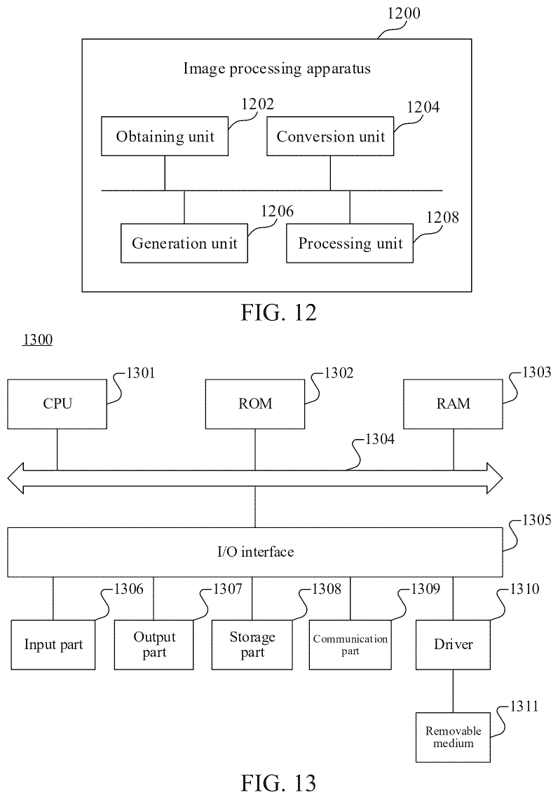

FIG. 12 is a block diagram of an image processing apparatus according to an embodiment of this application. The image processing apparatus may be used in a computer device. The computer device may be a server, or may be another device.

Referring to FIG. 12, the image processing apparatus 1200 according to an embodiment of this application includes: an obtaining unit 1202, a conversion unit 1204, a generation unit 1206, and a processing unit 1208.

The obtaining unit 1202 is configured to obtain a plurality of original images, and obtain description texts respectively corresponding to the plurality of original images. The conversion unit 1204 is configured to respectively convert the description texts respectively corresponding to the plurality of original images into text vectors, to obtain the text vectors respectively corresponding to the plurality of original images. The generation unit 1206 is configured to: perform clustering processing according to the text vectors respectively corresponding to the plurality of original images, to obtain a plurality of original image clusters, and generate a text embedded vector corresponding to each original image cluster. The processing unit 1208 is configured to perform semantic editing processing on original images in each original image cluster by using the text embedded vector corresponding to each original image cluster as a text guide feature, to obtain processed images, the processed images being used as sample images of a machine learning model.

In some embodiments of this application, based on the foregoing solution, the obtaining unit 1202 is configured to: obtain the plurality of original images used as negative sample data of the machine learning model; and generate, by using a pre-training model, natural language description respectively corresponding to the plurality of original images as the description texts respectively corresponding to the plurality of original images.

In some embodiments of this application, based on the foregoing solution, the processing unit 1208 is configured to: train an image generation model by using an image and a text prompt in a preset scenario, to obtain a trained image generation model; perform semantic editing processing on the original images in each original image cluster by using the trained image generation model and using the text embedded vector corresponding to each original image cluster as the text guide feature.

In some embodiments of this application, based on the foregoing solution, the generation unit 1206 is configured to: perform clustering processing according to the text vectors respectively corresponding to the plurality of original images, to obtain a plurality of text vector clusters; and map the plurality of text vector clusters to the plurality of original image clusters according to text vectors included in the plurality of text vector clusters and the text vectors respectively corresponding to the plurality of original images.

In some embodiments of this application, based on the foregoing solution, the sample image of the machine learning model includes a palm image, and the image processing apparatus 1200 further includes a detection unit, configured to detect a palm center region in the sample image; and a cropping unit, configured to crop the sample image by using the palm center region as a reference, to obtain a palm center image that includes the palm center region and that has a preset size; and a training unit, configured to train the machine learning model by using the palm center image of the preset size, to generate a trained palm print recognition model.

In some embodiments of this application, based on the foregoing solution, the detection unit is configured to: perform palm region detection on the sample image, to determine a palm region included in the sample image; perform key point detection on the palm region, and calculate a center of a palm center circle in the palm region according to detected key points; and determine a palm center region in the palm region according to the center of the palm center circle.

In some embodiments of this application, based on the foregoing solution, the palm center region includes a region represented by a circumscribed rectangle of the palm center circle, and the palm center circle is generated based on the center of the palm center circle and by using a set length as a radius. The detection unit is configured to expand a width and a height of the circumscribed rectangle by a set multiple by using a region in which the circumscribed rectangle is located as a reference, to obtain an expanded palm center region; and crop the expanded palm center region from the sample image, to obtain the palm center image.

In some embodiments of this application, based on the foregoing solution, the image processing apparatus 1200 further includes: an evaluation unit, configured to evaluate the sample image from the plurality of quality dimensions by using a pre-training image quality recognition model, to obtain evaluation values of the sample image in the plurality of quality dimensions; and filter the sample image according to the evaluation values of the sample image in the plurality of quality dimensions.

In some embodiments of this application, based on the foregoing solution, the pre-training image quality recognition model includes a multi-classification model. The evaluation unit is configured to recognize an evaluation value of the sample image in each category by using the multi-classification model, one category corresponding to one quality dimension.

In some embodiments of this application, based on the foregoing solution, the machine learning model includes a multi-modal large model, and the multi-modal large model includes an image encoder. The training unit is configured to: convert a weight matrix of a specified network layer in the image encoder into a low-rank matrix, where the specified network layer includes at least one of a linear layer and an attention layer; and update a parameter of the low-rank matrix in a process of training the machine learning model by using the palm center image of the preset size.

In some embodiments of this application, based on the foregoing solution, the trained palm print recognition model is configured to recognize whether an input palm print image is a living body palm print image, and the plurality of original images include at least one of a palm print image made from cropped paper and a palm model image.

FIG. 13 is a schematic structural diagram of a computer system adapted to implement a computer device according to an embodiment of this application. The computer device may be the server in the foregoing embodiments.

The computer system 1300 of the computer device shown in FIG. 13 is merely an example, and does not constitute any limitation on functions and use ranges of the embodiments of this application.

As shown in FIG. 13, the computer system 1300 may include a central processing unit (CPU) 1301, which may perform various suitable actions and processing based on a program stored in a read-only memory (ROM) 1302 or a program loaded from a storage part 1308 into a random access memory (RAM) 1303, for example, perform the method described in the foregoing embodiments. The RAM 1003 further stores various programs and data required for system operations. The CPU 1301, the ROM 1302, and the RAM 1303 are connected to each other by using a bus 1304. An input/output (I/O) interface 1005 is also connected to the bus 1004.

The following components are connected to the I/O interface 1305: an input part 1306 including a keyboard, a mouse, or the like, an output part 1307 including a cathode ray tube (CRT), a liquid crystal display (LCD), a speaker, or the like, a storage part 1308 including a hard disk, or the like, and a communication part 1309 including a network interface card such as a local area network (LAN) card or a modem. The communication part 1309 performs communication processing by using a network such as the Internet. A driver 1310 is also connected to the I/O interface 1305 as required. A removable medium 1311 such as a magnetic disk, an optical disc, a magneto-optical disk, or a semiconductor memory is mounted on the driver 1310 as required, so that a computer program read from the removable medium 1311 is installed into the storage part 1308 as required.

Particularly, according to an embodiment of this application, the processes described in the following by referring to the flowcharts may be implemented as computer software programs. For example, this embodiment of this application includes a computer program product. The computer program product includes a computer program carried on a computer-readable medium, and the computer program is configured to implement the methods shown in the flowcharts. In such an embodiment, by using the communication part 309, the computer program may be downloaded and installed from a network, and/or installed from the removable medium 311. When the computer program is executed by the CPU 1301, the various functions defined in the system of this application are executed.

The computer-readable medium shown in the embodiments of this application may be a computer-readable signal medium or a computer-readable storage medium or any combination thereof. The computer-readable storage medium may be, for example, but is not limited to, an electrical, magnetic, optical, electromagnetic, infrared, or semiconductor system, apparatus, or device, or any combination thereof. A more specific example of the computer-readable storage medium may include but is not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disk read-only memory (CD-ROM), an optical storage device, a magnetic storage device, or any appropriate combination thereof. In this application, the computer-readable storage medium may be any tangible medium that includes or stores a computer program. The computer program may be used by or in combination with an instruction execution system, apparatus, or device. In this application, the computer-readable signal medium may include a data signal in a baseband or propagated as a part of a carrier wave, the data signal carrying a computer-readable computer program. The data signal propagated in such a way may assume a plurality of forms, including, but not limited to, an electromagnetic signal, an optical signal, or any appropriate combination thereof. The computer-readable signal medium may be further any computer-readable medium in addition to the computer-readable storage medium. The computer-readable medium may send, propagate, or transmit a program that is used by or used in combination with the instruction execution system, apparatus, or device. The computer program included in the computer-readable medium may be transmitted by using any suitable medium, comprising but not limited to: a wireless medium, a wire, or the like, or any suitable combination thereof.

The flowcharts and block diagrams in the accompanying drawings illustrate possible system architectures, functions, and operations that may be implemented by a system, a method, and a computer program product according to various embodiments of this application. Each box in a flowchart or a block diagram may represent a module, a program segment, or a part of code. The module, the program segment, or the part of code includes one or more executable instructions configured to implement designated logic functions. In some implementations used as substitutes, functions annotated in boxes may alternatively occur in a sequence different from that annotated in an accompanying drawing. For example, actually two boxes shown in succession may be performed basically in parallel, and sometimes the two boxes may be performed in a reverse sequence. This is determined by a related function. Each box in a block diagram or a flowchart and a combination of boxes in the block diagram or the flowchart may be implemented by using a dedicated hardware-based system configured to perform a specified function or operation, or may be implemented by using a combination of dedicated hardware and a computer program.

Related units described in the embodiments of this application may be implemented in a software manner, or may be implemented in a hardware manner, and the described unit can also be set in a processor. Names of these units do not constitute a limitation on the units in a case.

According to another aspect, this application further provides a computer-readable medium. The computer-readable medium may be included in the computer device described in the foregoing embodiments, or may exist alone and is not assembled in the computer device. The computer-readable medium carries one or more computer programs, and when the one or more computer programs are executed by the computer device, the computer device is caused to implement the method in the foregoing embodiment.

Although a plurality of modules or units of a device configured to perform actions are discussed in the foregoing detailed description, such division is not mandatory. Actually, according to the implementations of this application, the features and functions of two or more modules or units described above may be specified in one module or unit. Conversely, features and functions of one module or unit described above may be further divided into a plurality of modules or units to be specified.

Through the descriptions of the foregoing implementations, a person skilled in the art easily understands that the exemplary implementations described herein may be implemented through software, or may be implemented by combining software with necessary hardware. Therefore, the technical solutions of the implementations of this application may be implemented in a form of a software product. The software product may be stored in a non-volatile storage medium (which may be a CD-ROM, a USB flash drive, a removable hard disk, or the like) or on a network, and includes several instructions for instructing a computer device to perform the methods according to the implementations of this application. For example, the computer device may perform the image processing method shown in FIG. 4 and FIG. 5.

Based on the foregoing, this application provides the image processing method and apparatus, the computer-readable medium, the computer device, and the computer program product. A plurality of original images and description texts corresponding to the plurality of original images are obtained; the description texts are respectively converted into text vectors; clustering processing is performed according to the text vectors to obtain a plurality of original image clusters, corresponding text embedded vectors are generated; and semantic editing processing is performed on original images in each original image cluster by using a text embedded vector as a text guide feature, to obtain sample images of a machine learning model. In this procedure, image information is converted into a quantizable and analyzable text vector form. A clustering operation groups images according to semantic similarity, and semantic editing increases image semantic diversity. This enables a training data set to cover more image features in different scenarios, postures, lighting, and the like, and greatly improves a generalization capability of the model, so that the model can implement accurate recognition when facing an unseen image, to reduce a phenomenon of overfitting, improve robustness and accuracy of the model, and enhance performance and reliability of the mode in actual application.

Further, the plurality of original images used as negative sample data of the machine learning model are obtained, and natural language description respectively corresponding to the original images is generated by using a pre-training model as the description texts. A feature mode of an abnormal case can be learned by the model by using the negative sample data, to enhance a capability of distinguishing a non-target sample by the model. The pre-training model has a strong image-text association capability, can accurately capture key information in an image and convert the key information into a natural language description, and provides a high-quality data basis for subsequent text vector conversion. An accurate text description enables a text vector to reflect semantic information of an image more accurately, to improve accuracy of clustering and semantic editing, so that the model can better learn of features of a negative sample, to improve overall performance and an anti-interference capability of the model.

Further, an image generation model is trained by using an image and a text prompt in a preset scenario, to obtain a trained image generation model, and semantic editing processing is performed on the original images by using the trained image generation model by using the text embedded vector corresponding to each original image cluster as the text guide feature. The image generation model is trained in the set scenario, so that a parameter of the model is more adaptive to an image feature and a semantic relationship in a specific scenario. Semantic editing is performed by using the text embedded vector as a guide, so that images that are highly correlated to the specific scenario and have different semantic features can be generated, thereby further enriching diversity of training data sets in the specific scenario. This helps the model better learn an image feature and a change law in the specific scenario, improves an adaptability and recognition accuracy of the model in the specific scenario, and enhances pertinence and effectiveness of the model in actual application.

Further, clustering processing is performed on the text vectors respectively corresponding to the plurality of original images, to obtain a plurality of text vector clusters, and the text vector clusters are mapped to the plurality of original image clusters according to text vectors included in the text vector clusters and the text vectors respectively corresponding to the plurality of original images. Text vector clustering enables initial classification of images based on semantic similarity, and images with similar semantics are classified as a same cluster. This semantic-based clustering manner enables images in a same image cluster to have a similar feature pattern, to provide more reasonable grouping for subsequent semantic editing processing. The text vector clusters are mapped to the image clusters, so that the images are organized and managed more efficiently, to improve image processing efficiency and quality. In addition, this helps the model learn of a more targeted feature pattern, to improve a feature extraction capability and recognition performance of the model.

Further, when the sample image of the machine learning model includes a palm image, a palm center region in the sample image is detected. The sample image is cropped by using the palm center region as a reference, to obtain a palm center image that includes the palm center region and that has a preset size, and the machine learning model is trained by using the palm center image of the preset size, to generate a trained palm print recognition model. The palm center region is a region in which palm print features are most concentrated. A key feature of a palm print can be highlighted by detecting and cropping the palm center region, to reduce interference of irrelevant information such as a background. A palm image with a uniform size enables the model to learn a palm print feature pattern more stably in a training process, to avoid training instability caused by image size inconsistency. This improves accuracy and robustness of the palm print recognition model, so that a palm print can be more accurately recognized in actual application.

Further, when the palm center region in the sample image is detected, palm region detection is first performed on the sample image, to determine a palm region, then key point detection is performed on the palm region, and a center of a palm center circle in the palm region is calculated according to detected key points, and finally, the palm center region in the palm region is determined according to the center of the palm center circle. A position and a posture of a palm can be accurately positioned through palm region detection and key point detection, to provide an accurate basis for calculating the center of the palm center circle. A position and a range of the palm center region can be determined more accurately based on the center of the palm center circle obtained through key point calculation, so that the cropped palm center image can completely include the key feature of the palm print. This improves accuracy of palm print feature extraction, thereby improving performance of the palm print recognition model.

Further, the palm center region includes a region represented by a circumscribed rectangle of the palm center circle, and the palm center circle is generated based on the center of the palm center circle and by using a set length as a radius. When the sample image is cropped by using the palm center region as a reference, a width and a height of the circumscribed rectangle are expanded by a set multiple by using a region in which the circumscribed rectangle is located as a reference, to obtain an expanded palm center region, and then the expanded palm center region is cropped from the sample image, to obtain the palm center image. Expansion cropping of the palm center region can ensure that complete information of the palm is included in the cropped image, to avoid loss of some palm print features due to an excessively small cropping range. In addition, the cropped palm image has approximately a same size, which facilitates uniform processing of the model, improves stability and efficiency of model training, and helps improve performance of the palm print recognition model.

Further, before the palm center region in the sample image is detected, the sample image is evaluated from a plurality of quality dimensions by using a pre-training image quality recognition model, to obtain evaluation values of the sample image in the plurality of quality dimensions, and filtering processing is performed on the sample image according to the evaluation values. The pre-training image quality recognition model can evaluate quality of the sample image from a plurality of perspectives, such as definition, brightness, contrast, and inclination. A corresponding threshold is set, and images that do not meet a quality requirement are filtered, so that low-quality images can be removed, thereby avoiding negative impact generated by these images on model training. High-quality sample images provide more accurate and clear feature information for the model, improve accuracy and efficiency of model training, and improve overall performance of the model.

Further, the pre-training image quality recognition model includes a multi-classification model. an evaluation value of the sample image in each category is recognized by using the multi-classification model, one category corresponding to one quality dimension. The multi-classification model can independently evaluate the sample image from each quality dimension, and accurately determine quality conditions of the image in different dimensions. One category corresponds to one quality dimension, so that an evaluation result is more detailed and accurate, and provides a more scientific basis for image filtering. Image filtering is performed based on an evaluation result of the multi-classification model, so that it can be ensured that quality of an image that enters model training meets a requirement, to improve an effect and performance of model training.

Further, when the machine learning model includes a multi-modal large model, and the multi-modal large model includes an image encoder, and when the machine learning model is trained by using the palm center image of the preset size, a weight matrix of a specified network layer in the image encoder is converted into a low-rank matrix, where the specified network layer includes at least one of a linear layer and an attention layer; and a parameter of the low-rank matrix is updated in a training process. The multi-modal large model has learned of rich semantic features on a large-scale data set, but these features may not be completely applicable to a specific palm print recognition task. The weight matrix of the specified network layer is converted into the low-rank matrix, so that when most parameters of the pre-training model remain unchanged, the model can be fine-tuned to adapt to a new task. This low-rank fine tuning method reduces a quantity of parameters that need to be updated, reduces a requirement of a computing resource, avoids an overfitting problem that may be caused by full-parameter fine tuning, and improves efficiency and performance of model training.

Further, the trained palm print recognition model is configured to recognize whether an input palm print image is a living body palm print image. The plurality of original images include at least one of a palm print image made from cropped paper and a palm model image. Training is performed by using attack samples such as the palm print image made from cropped paper and the palm model image, so that the model can learn of a feature pattern of a non-living body palm print, to improve a capability of recognizing the non-living body palm print image by the model. In actual application, the model can accurately distinguish the living body palm print from the non-living body palm print, to effectively improve security and reliability of palm print recognition.

In addition, in a diffusion model-based training data generation process, LoRA fine-tuning is performed on a generation model by using palm living body data. In the LoRA fine-tuning, a weight matrix of the model is adjusted in a low-rank decomposition manner. In the training process, only a parameter of the low-rank matrix is updated, and most parameters of the original weight matrix remain unchanged. In this method, a requirement of a computing resource is greatly reduced. In addition, the model can quickly adapt to the palm living body data, to improve alignment between an image generation model and living body data. Through LoRA fine-tuning, the image generation model can better learn of a feature pattern of the palm living body data, to lay a foundation for subsequent generation of a high-quality attack image.

In terms of semantic-based image clustering and textual embedding processing, content summarization and textual embedding are performed on living body attach data, to obtain a text embedded vector of each image cluster. In this processing manner, semantic information of an image is quantized and organized, so that each image cluster has a clear semantic representation. In a subsequent image generation process, an image having a particular semantic feature may be generated by using a text embedded vector as a guide, thereby improving semantic accuracy and diversity of generated images. Through semantic clustering and textual embedding, latent semantic information in image data can be better mined, to provide a more valuable sample for model training.

In terms of SDEdit-based image generation, semantic editing is performed on images by using text embedded vectors as guides, to generate attack images having different semantic features. The SDEdit technology combines a strong generation capability and a text-to-image editing capability of the diffusion model, and local or global modification can be performed on an existing image according to a text prompt. Semantic editing is performed by using the text embedded vector as the guide, so that attack images having features such as different postures, lighting, and backgrounds can be generated, thereby further enriching diversity of training data sets. These diversified attack images enable the model to learn of more attack feature patterns, thereby improving a learning capability of the model on an attack feature, and enhancing an attack interception capability of the model.

When palm key point detection and processing are performed on a training sample image, during palm RoI detection, a faulty image, for example, a smudged palm print, a blur image, an over-exposed image, over-dark light, or an excessively large inclination angle of a palm, is filtered by using an image quality determining algorithm. These low-quality images may cause misjudgment of living body detection, and quality of the sample image can be improved through filtering processing, to provide a more reliable data basis for subsequent processing. In addition, a detection box in which a palm is located is accurately detected, which provides accurate region information for subsequent key point detection and a cropping operation.

Through palm key point detection, 21 key points in a palm region are obtained, and these key points include a shape, a posture, and structure information of a palm. Through key point detection, parts of the palm can be accurately positioned, which provides an accurate basis for calculating a center of a palm center circle and a palm cropping box. A palm center region and a cropping range can be determined more accurately through key point-based calculation, so that a cropped image can completely include key features of a palm print.

In terms of palm image cropping, cropping is performed by using a palm center circle as a center, and a width and a height of a cropping region are respectively expanded by 150%. Such a cropping manner can ensure that complete palm information appears in the cropping region, and reduce interference of a background to the living body detection model. In addition, a unified cropping manner enables features of different sample images to be consistent, thereby facilitating learning and training of the model, and improving stability and accuracy of model training.

The image encoder of the multi-modal large model is processed by using a LoRA low-rank fine-tuning method, so that the model quickly adapts to a palm print recognition task when most parameters of the pre-training model remain unchanged. In the LoRA low-rank fine-tuning, a quantity of parameters that need to be updated is reduced in a low-rank decomposition manner, and an overfitting problem caused by full-parameter fine-tuning is also avoided. According to the method, a strong feature extraction capability of the pre-training model can be fully used, and the model can quickly adapt to a new task, so that efficiency and performance of model training are improved.

In the multi-modal large model architecture-based deep learning classification model, feature extraction is performed on the original image by using the image encoder of the multi-modal large model, and authenticity of a palm print image is determined by using a fully connected neural network layer. The multi-modal large model learns of rich semantic features from a large-scale data set, and can effectively extract a key feature in the original image. The fully connected neural network can perform classification and determining according to the extracted feature, thereby implement authenticity identification of the palm print image. In a training fine-tuning phase, through cooperation of the low-rank conversion image encoder and the fully connected layer, parameters of the model are continuously optimized, thereby improving accuracy and reliability of palm print recognition.

After model training is completed, living body detection is performed on the palm print image by using a trained model. In actual application, a user captures a registered image of a palm, a position and key points of the palm are automatically detected by using an application program of a terminal device, then image matting is performed to remove background interference, and a processed palm print image is transferred to a background server for living body detection. This processing manner can effectively improve security and reliability of palm print recognition, avoid interference of the background information to living body detection, ensure that detection only on a real living body palm print image can succeed, and improve accuracy and credibility of palm print authentication.

After considering the specification and practicing the implementations disclosed herein, a person skilled in the art is to easily conceive of other implementations of this application. This application is intended to cover any variations, uses or adaptive changes of this application. Such variations, uses or adaptive changes follow the general principles of this application, and include well-known knowledge and conventional technical means in the art that are not disclosed in this application.

The technical features in the foregoing embodiments may be randomly combined. For concise description, not all possible combinations of the technical features in the embodiment are described. However, provided that combinations of the technical features do not conflict with each other, the combinations of the technical features are considered as falling within the scope recorded in this specification.

The foregoing embodiments only describe several implementations of this application, which are described specifically and in detail, and therefore cannot be construed as a limitation to the patent scope of the present disclosure. A person of ordinary skill in the art may make various changes and improvements without departing from the ideas of this application, which shall all fall within the protection scope of this application. Therefore, the protection scope of this patent application is subject to the protection scope of the appended claims.

What is claimed is:

1. An image processing method, performed by a computer device, and the method comprising:
obtaining a plurality of original images and description texts respectively corresponding to the plurality of original images;
converting the description texts respectively corresponding to the plurality of original images into text vectors respectively corresponding to the plurality of original images;
performing clustering on the text vectors respectively corresponding to the plurality of original images, to obtain a plurality of original image clusters, each original image cluster having a corresponding text embedded vector; and
performing semantic editing on images in the plurality of original image clusters by using their corresponding text embedded vectors, to obtain sample images of a machine learning model.

2. The method according to claim 1, wherein the obtaining a plurality of original images and description texts respectively corresponding to the plurality of original images comprises:
obtaining the plurality of original images from negative sample data of the machine learning model; and
generating, by using a pre-training model, natural language description respectively corresponding to the plurality of original images as the description texts respectively corresponding to the plurality of original images.

3. The method according to claim 1, wherein the performing semantic editing on images in the plurality of original image clusters by using their corresponding text embedded vectors, to obtain sample images of a machine learning model comprises:
training an image generation model by using an image and a text prompt in a preset scenario, to obtain a trained image generation model; and
performing semantic editing on the original images in the plurality of original image clusters by using the trained image generation model and the corresponding text embedded vectors.

4. The method according to claim 1, wherein the performing clustering on the text vectors respectively corresponding to the plurality of original images, to obtain a plurality of original image clusters comprises:
performing clustering on the text vectors respectively corresponding to the plurality of the original images, to obtain a plurality of text vector clusters; and
mapping the plurality of text vector clusters to the plurality of original image clusters according to text vectors comprised in the plurality of text vector clusters and the text vectors respectively corresponding to the plurality of original images.

5. The method according to claim 1, wherein the sample image of the machine learning model comprises a palm image, and the image processing method further comprises:
detecting a palm center region in the sample image;
cropping the sample image by using the palm center region to obtain a palm center image that has a preset size of the palm center region; and
training the machine learning model by using the palm center image of the preset size, to generate a trained palm print recognition model.

6. The method according to claim 5, wherein the detecting a palm center region in the sample image comprises:
detecting a palm region and a plurality of key points comprised in the sample image;
calculating a center of a palm center circle in the palm region according to detected key points; and
determining the palm center region in the palm region according to the center of the palm center circle.

7. The method according to claim 5, wherein the machine learning model comprises a multi-modal model, and the multi-modal model comprises an image encoder; and the training the machine learning model by using the palm center image of the preset size comprises:
converting a weight matrix of a specified network layer in the image encoder into a low-rank matrix, the specified network layer comprising at least one of a linear layer and an attention layer; and
updating a parameter in the low-rank matrix in a process of training the machine learning model by using the palm center image of the preset size.

8. The method according to claim 5, wherein the trained palm print recognition model is configured to recognize whether an input palm print image is a living body palm print image.

9. The method according to claim 1, wherein the plurality of original images comprise at least one of a palm print image made from cropped paper and a palm model image.

10. A computer device, comprising:
one or more processors; and
a memory, configured to store one or more computer programs, the one or more computer programs, when executed by the one or more processors, causing the computer device to implement an image processing method including:
obtaining a plurality of original images and description texts respectively corresponding to the plurality of original images;
converting the description texts respectively corresponding to the plurality of original images into text vectors respectively corresponding to the plurality of original images;
performing clustering on the text vectors respectively corresponding to the plurality of original images, to obtain a plurality of original image clusters, each original image cluster having a corresponding text embedded vector; and
performing semantic editing on images in the plurality of original image clusters by using their corresponding text embedded vectors, to obtain sample images of a machine learning model.

11. The computer device according to claim 10, wherein the obtaining a plurality of original images and description texts respectively corresponding to the plurality of original images comprises:
obtaining the plurality of original images from negative sample data of the machine learning model; and
generating, by using a pre-training model, natural language description respectively corresponding to the plurality of original images as the description texts respectively corresponding to the plurality of original images.

12. The computer device according to claim 10, wherein the performing semantic editing on images in the plurality of original image clusters by using their corresponding text embedded vectors, to obtain sample images of a machine learning model comprises:
training an image generation model by using an image and a text prompt in a preset scenario, to obtain a trained image generation model; and
performing semantic editing on the original images in the plurality of original image clusters by using the trained image generation model and the corresponding text embedded vectors.

13. The computer device according to claim 10, wherein the performing clustering on the text vectors respectively corresponding to the plurality of original images, to obtain a plurality of original image clusters comprises:
performing clustering on the text vectors respectively corresponding to the plurality of the original images, to obtain a plurality of text vector clusters; and
mapping the plurality of text vector clusters to the plurality of original image clusters according to text vectors comprised in the plurality of text vector clusters and the text vectors respectively corresponding to the plurality of original images.

14. The computer device according to claim 10, wherein the sample image of the machine learning model comprises a palm image, and the image processing method further comprises:
detecting a palm center region in the sample image;
cropping the sample image by using the palm center region to obtain a palm center image that has a preset size of the palm center region; and
training the machine learning model by using the palm center image of the preset size, to generate a trained palm print recognition model.

15. The computer device according to claim 14, wherein the detecting a palm center region in the sample image comprises:
detecting a palm region and a plurality of key points comprised in the sample image;
calculating a center of a palm center circle in the palm region according to detected key points; and
determining the palm center region in the palm region according to the center of the palm center circle.

16. The computer device according to claim 14, wherein the machine learning model comprises a multi-modal model, and the multi-modal model comprises an image encoder; and the training the machine learning model by using the palm center image of the preset size comprises:
converting a weight matrix of a specified network layer in the image encoder into a low-rank matrix, the specified network layer comprising at least one of a linear layer and an attention layer; and
updating a parameter in the low-rank matrix in a process of training the machine learning model by using the palm center image of the preset size.

17. The computer device according to claim 14, wherein the trained palm print recognition model is configured to recognize whether an input palm print image is a living body palm print image.

18. The computer device according to claim 14, wherein the plurality of original images comprise at least one of a palm print image made from cropped paper and a palm model image.

19. A non-transitory computer-readable medium having a computer program stored therein, wherein the computer program, when executed by a processor of a computer device, causes the computer device to implement an image processing method including:
obtaining a plurality of original images and description texts respectively corresponding to the plurality of original images;
converting the description texts respectively corresponding to the plurality of original images into text vectors respectively corresponding to the plurality of original images;
performing clustering on the text vectors respectively corresponding to the plurality of original images, to obtain a plurality of original image clusters, each original image cluster having a corresponding text embedded vector; and
performing semantic editing on images in the plurality of original image clusters by using their corresponding text embedded vectors, to obtain sample images of a machine learning model.

20. The non-transitory computer-readable medium according to claim 19, wherein the performing semantic editing on images in the plurality of original image clusters by using their corresponding text embedded vectors, to obtain sample images of a machine learning model comprises:
training an image generation model by using an image and a text prompt in a preset scenario, to obtain a trained image generation model; and
performing semantic editing on the original images in the plurality of original image clusters by using the trained image generation model and the corresponding text embedded vectors.
